(19) United States
(12) Patent Application Publication
(10) Pub. No.: US 2014/0340605 A1
(43) Pub. Date: Nov. 20, 2014

(54) LIQUID CRYSTAL DISPLAY PANEL

(71) Applicant: Mitsubishi Electric Corporation, Tokyo (JP)

(72) Inventors: Kazuhiro TAKEDA, Tokyo (JP); Shiro MIYAKE, Tokyo (JP); Shingo NAGANO, Tokyo (JP); Naruhito HOKA, Tokyo (JP)

(73) Assignee: MITSUBISHI ELECTRIC CORPORATION, Tokyo (JP)

(21) Appl. No.: 14/268,268

(22) Filed: May 2, 2014

(30) Foreign Application Priority Data
May 15, 2013 (JP) 2013-102687

(51) Int. Cl. G02F 1/1362

(52) U.S. Cl. CPC G02F 1/136286
USPC 349/43

(57) ABSTRACT

A liquid crystal panel includes a TFT array substrate and an opposite substrate, which are arranged opposite to each other. The TFT array substrate has a gate lead wire that draws a gate wire, connected to a gate electrode of a TFT, to a frame area outside a display area. A conductive layer that covers an outermost surface of the TFT array substrate is provided in the frame area on all sides including a side where the gate lead wire is not arranged.

### BACKGROUND OF THE INVENTION

1. Field of the Invention

The present invention relates to a liquid crystal display device, and more particularly to an enhancement of a display quality and reliability of a liquid crystal display device of a transverse electric field mode.

2. Description of the Background Art

Conventionally, a TN (Twisted Nematic) mode has widely been used as a driving system of liquid crystal in a liquid crystal display device. However, in recent years, a liquid crystal display device of a transverse electric field mode has been in widespread use, instead of the liquid crystal display device of the TN mode. In the liquid crystal display device of the transverse electric field mode, an electric field in almost a horizontal direction (transverse direction) relative to a surface of a display panel is generated when a voltage is applied between a pixel electrode and a common electrode (opposite electrode), and a liquid crystal molecule is driven by using the transverse electric field. The liquid crystal display device of the transverse electric field mode has wide viewing angle, and can bring a high display quality within any viewing range.

As the transverse electric field mode, In-Plane Switching mode and FFS (Fringe Field Switching) mode are well-known. In the FFS mode, in particular, a pixel electrode and a common electrode, which drive liquid crystal, are made of a transparent conductive film, and the liquid crystals in almost all areas on the pixel electrode and the common electrode are driven to be contributed to a display. Therefore, the FFS mode has higher light use efficiency than the In-Plane Switching mode. Accordingly, the FFS mode can attain an increase in brightness and reduction in power consumption in a level equal to or higher than a level in the TN mode, as well as attain a wide viewing angle and high definition. In addition, the electrode structure is simpler in the FFS mode than in the In-Plane Switching mode, so that the FFS mode is structurally advantageous for attaining high definition.

A middle-sized or small-sized panel used for a smartphone or a tablet terminal, which is a promising product category in the future, is highly required to attain high definition and an increase in brightness or reduction in power consumption. Therefore, a liquid crystal display device of the FFS mode that can realize these requirements has been a mainstream in this product category.

In general, a liquid crystal display panel (hereinafter referred to as a “liquid crystal panel”) forming a liquid crystal display device has a structure including a liquid crystal layer sandwiched between a TFT array substrate on which a TFT (Thin Film Transistor), a pixel electrode and the like are formed and an opposite substrate on which a color filter, a black matrix (BM), and the like are formed. In the liquid crystal panel of the transverse electric field mode, the pixel electrode and the opposite electrode are both provided on the TFT array substrate, so that it is basically unnecessary to provide electrodes on the opposite substrate. Therefore, in the liquid crystal panel of the transverse electric field mode, a conductive film is not formed on an inner side of the opposite substrate (at the side close to the liquid crystal layer). Accordingly, a potential of the opposite substrate is liable to be unstable, and external electromagnetic noise might enter the liquid crystal layer to affect an image quality.

In order to solve this problem, a shield conductive layer made of a transparent conductive film of ITO (Indium Tin Oxide) or the like has been provided on an outer side of the opposite substrate in the liquid crystal display device of the transverse electric field mode. In general, the shield conductive layer provided on the opposite substrate is grounded (earth-connected) in order to stabilize a potential. Examples of a method of grounding the shield conductive layer include a method of connecting a grounded conductive metal housing or a terminal electrode to the shield conductive layer via a silver paste or a metal tape, and a method of allowing a part of a grounded metal housing to have a spring structure connected to the shield conductive layer.

By providing the shield conductive layer on the outer side of the opposite substrate, electromagnetic noise from the outside of the liquid crystal panel can be shielded, and further, the outer surface of the opposite substrate can stably hold a ground potential by grounding the shield conductive layer. However, it is difficult to take a countermeasure for generation of charging generated in the liquid crystal panel. In particular, a portion in the vicinity of a screen where a gate lead wire to which a gate signal with relatively a high potential is applied is provided is susceptible to the influence of the gate signal, resulting in generation of charging in the liquid crystal panel. As a result, a “void” in which contrast is deteriorated is generated in the vicinity of the screen. The degree of generation of the void is different depending upon a place according to a magnitude of conductivity at each portion of the inner surface of the liquid crystal panel. For example, the void might appear as light leakage of a specific color, when color materials of the color filter on the opposite substrate have different conductivity.

Japanese Patent Application Laid-Open No. 2010-049185 proposes a technique of improving a void caused by a gate signal applied to a gate lead wire by providing a shield conductive layer on the gate lead wire on a TFT array substrate via an insulating film, in a liquid crystal display device of a transverse electric field mode. The shield conductive layer in Japanese Patent Application Laid-Open No. 2010-049185 extends to a portion below a seal material that seals liquid crystal on an outer periphery of a liquid crystal panel to cover the gate lead wire from above.

As described previously, the grounded shield conductive layer is provided on the outer side of the opposite substrate in the liquid crystal display device of the transverse electric field mode to prevent charging caused by the external electromagnetic noise. However, if the ground structure for the shield conductive layer becomes non-functional for some reason (e.g., disconnection), charges are accumulated in the shield conductive layer. In this case, non-uniform electric field according to a magnitude of capacitance, which is formed by the shield conductive layer in which the charges are accumulated and each conductor in the liquid crystal panel, is applied to the liquid crystal layer, whereby display unevenness caused by a void occurs.

In the opposite substrate, in particular, many charges are induced on the portion of the black matrix having low resistance value. The black matrix is locally formed in a display area, but in a frame area outside the display area, the black matrix is entirely formed. Therefore, different electric field is locally applied to the liquid crystal on the portion of the display area close to the frame area, i.e., on the outer periphery of the display area, and this causes display unevenness.

On the other hand, the shield conductive layer formed on the TFT array substrate in Japanese Patent Application Laid-Open No. 2010-049185 aims only to shield an electric field from the gate lead wire, and the shield conductive layer is provided only on a side where the gate lead wire is provided, out of four sides of the rectangular liquid crystal panel. Therefore, the electric field caused by the charges induced by the black matrix is different between the side where the shield conductive layer is provided and the sides where the shield conductive layer is not provided. As a result, different electric field is locally applied to the liquid crystal on the outer periphery of the display area, in particular, on the sides where the shield conductive layer is not provided, resulting in the occurrence of display unevenness occurs on this portion.

Specifically, even in the liquid crystal display device described in Japanese Patent Application Laid-Open No. 2010-049185, the display unevenness caused by the charging generated in the liquid crystal panel cannot sufficiently be reduced under the condition where the ground structure for the shield conductive layer becomes non-functional.

The degree of the generation of the void is different according to the magnitude of the conductivity at each portion of the inner surface of the liquid crystal panel. Therefore, it is effective that the shield conductive layer provided on the TFT array substrate is provided on the outermost surface of the TFT array substrate. The shield conductive layer in Japanese Patent Application Laid-Open No. 2010-049185 is formed in the same layer as the common electrode provided below the insulating film, which means the shield conductive layer is provided not on the outermost surface of the TFT array substrate but below the insulating film.

The ground structure for the shield conductive layer provided on the outer side of the opposite substrate needs a process of forming a silver paste or a metal tape. This leads to a complicated manufacturing process, and further leads to cost increase and reliability degradation due to increase in the number of components, caused by the complicated process. Alternatively, the ground structure for the shield conductive layer provided on the outer side of the opposite substrate leads to reduction in design freedom of a metal housing because of a spring structure formed on a part of the metal housing.

As described above, satisfactory means for solving the problems of reliability, cost, and the display unevenness caused by the charging in the liquid crystal panel has not been proposed for a liquid crystal display device of a transverse electric field mode.

### SUMMARY OF THE INVENTION

The present invention aims to provide a liquid crystal display device of a transverse electric field mode that can effectively suppress display unevenness on an outer periphery of a display area.

A liquid crystal display panel according to the present invention is a liquid crystal display panel of a transverse electric field mode that includes a TFT array substrate on which a TFT (Thin Film Transistor) for each pixel is provided; an opposite substrate that is arranged opposite to the TFT array substrate and includes a shield conductive layer covering a display area; and a liquid crystal layer sandwiched between the TFT array substrate and the opposite substrate. The TFT array substrate includes a gate wire connected to a gate electrode of the TFT, and a gate lead wire that draws the gate wire to a frame area outside the display area. The TFT array substrate also includes a conductive layer that covers an outermost surface of the TFT array substrate in the frame area on all sides including a side where the gate lead wire is not arranged.

In the liquid crystal display device according to the present invention, the conductive layer is formed on the outermost surface of the frame area on all sides including the side where the gate lead wire is not arranged. This configuration can prevent a local generation of a different electric field on an end of the display area where display unevenness is likely to be generated, thereby effectively preventing the display unevenness. Accordingly, the generation of the display unevenness can be prevented, for example, even when a ground structure for the shield conductive layer becomes non-functional, or the ground structure is eliminated. The prevention of the display defect caused by the defective ground structure makes it possible to enhance reliability. Alternatively, the elimination of the ground structure makes it possible to achieve the simplification of a manufacturing process and cost reduction.

When a resistance value of a surface of a seal material sealing the liquid crystal layer is smaller than a resistance value of the liquid crystal, charges on the surface of the opposite substrate flow into the conductive layer through the surface of the substrate and the surface of the seal material in the vicinity of the seal material. Thus, a potential difference between the surface of the opposite substrate and the surface of the TFT array substrate, i.e., an electric field in a longitudinal direction (vertical direction relative to the surface of the display panel) applied to the liquid crystal, is relaxed, and this contributes to the prevention of the display unevenness.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view illustrating a configuration of a liquid crystal panel according to a first preferred embodiment;

FIG. 2 is a sectional view illustrating the configuration of the liquid crystal panel according to the first preferred embodiment;

FIGS. 3 and 4 are sectional views illustrating a vicinity of a frame area in the liquid crystal panel according to the first preferred embodiment;

FIGS. 5 and 6 are sectional views illustrating a vicinity of a frame area in a liquid crystal panel according to a second preferred embodiment; and

FIGS. 7 and 8 are sectional views illustrating a vicinity of a frame area in a liquid crystal panel according to a fourth preferred embodiment.

### DESCRIPTION OF THE PREFERRED EMBODIMENTS

### First Preferred Embodiment

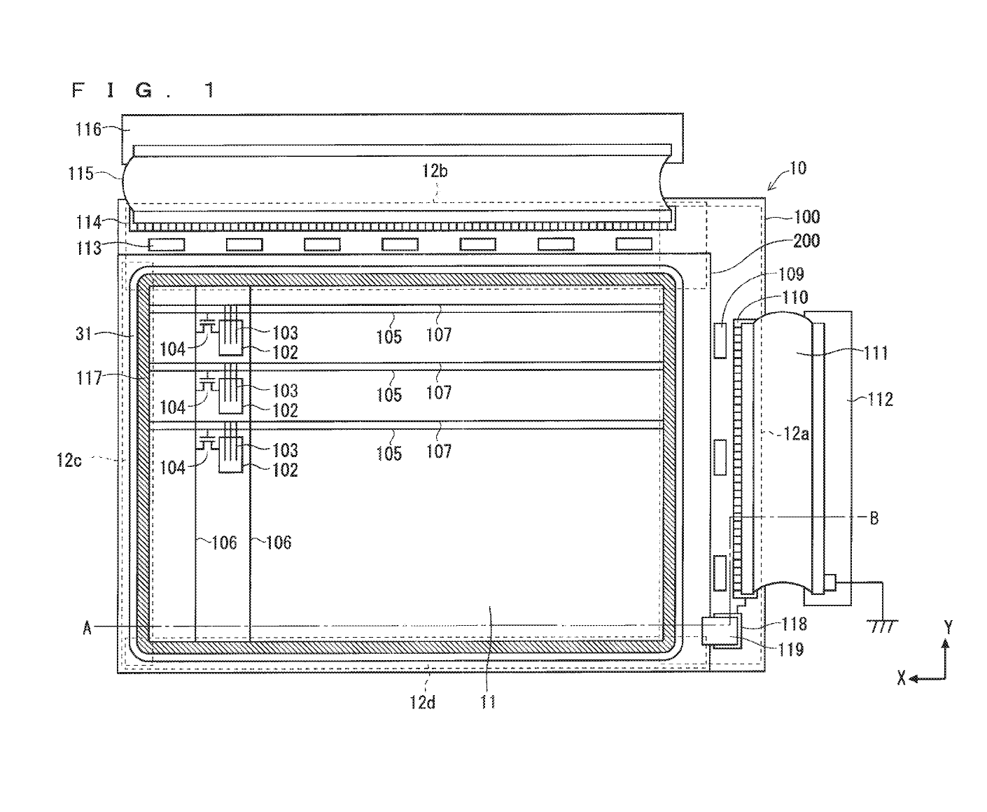

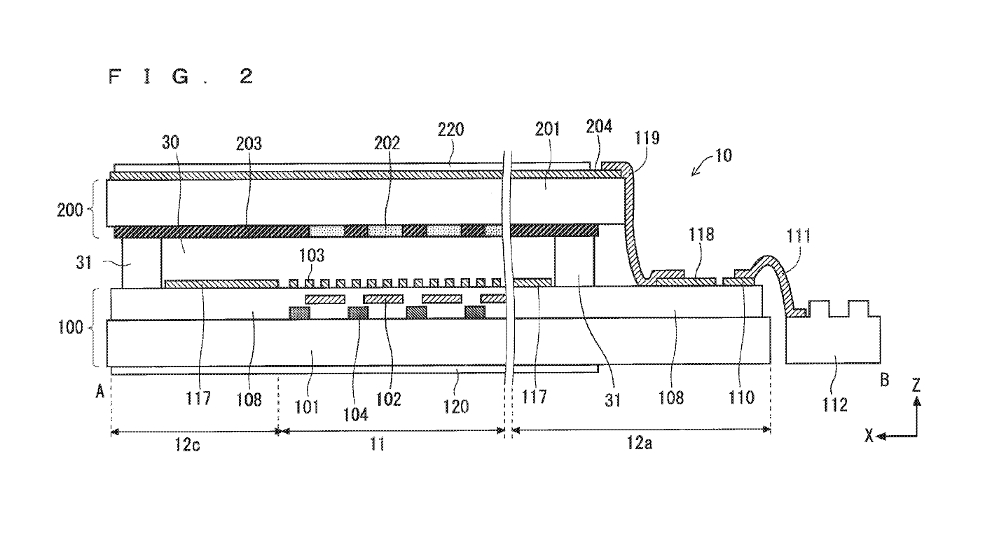

FIGS. 1 and 2 are schematic views illustrating a liquid crystal panel forming a liquid crystal display device according to a first preferred embodiment of the present invention. FIG. 1 is a plan view illustrating an overall structure of the liquid crystal panel, and FIG. 2 is a sectional view taken along a line A-B in FIG. 1. In the present preferred embodiment, the present invention is applied to a liquid crystal panel of a transverse electric field mode using a TFT as a switching element for each pixel, in particular, to a liquid crystal panel of a FFS mode.

A liquid crystal panel 10 has a structure including a liquid crystal layer 30 sandwiched between a TFT array substrate 100 on which TFTs 104 for respective pixels are formed and an opposite substrate 200 that is a color filter substrate arranged opposite to the TFT array substrate 100. The TFT array substrate 100 and the opposite substrate 200 are bonded to each other via a seal material 31 provided to enclose a display area 11 on which a plurality of pixels are arranged. The liquid crystal layer 30 is sealed by the seal material 31. Specifically, the seal material 31 is provided on a frame area 12 (12a to 12d) outside the display area 11. Although not illustrated, many columnar spacers for keeping a constant space between the TFT array substrate 100 and the opposite substrate 200 are arranged in the display area 11.

The frame area 12 is a frame-like area enclosing the rectangular display area 11. In the description below, the frame area on the right side of the liquid display panel 10 is referred to as a “frame area 12a”, the frame area on the top side of the liquid display panel 10 is referred to as a “frame area 12b”, the frame area on the left side of the liquid display panel 10 is referred to as a “frame area 12c”, and the frame area on the bottom side of the liquid display panel 10 is referred to as a “frame area 12d” as illustrated in FIG. 1. It is supposed that the display area 11 and the frame area 12 are specified not only on the liquid crystal panel 10 but also on the TFT array substrate 100, on the opposite substrate 200, or a space (including the liquid crystal layer 30) between the TFT array substrate 100 and the opposite substrate 200.

As illustrated in FIG. 2, the opposite substrate 200 is formed by using a glass substrate 201 that is a first transparent substrate. Color filters 202 of respective colors are arranged in the display area 11 on the inner surface (the surface close to the liquid crystal layer 30) of the glass substrate 201, while a black matrix (BM) 203 that is a light-shielding layer is formed between the color filters 202 and in the frame area 12.

Although not illustrated, an orientation film for aligning the liquid crystal in the liquid crystal layer 30 is provided in the display area 11 on the surface of the opposite substrate 200 close to the liquid crystal layer 30 so as to cover the color filters 202 and the black matrix 203. In order to assure uniformity of a substrate space (the space between the TFT array substrate 100 and the opposite substrate 200) required in the liquid crystal display device of the transverse electric field mode, a transparent resin layer (overcoat layer) that flattens the surface of the opposite substrate 200 may be formed between the color filters 202 as well as the black matrix 203 and the orientation film.

A color material layer having pigments dispersed in resin can be used for the color filter 202, for example. The color filter 202 functions as a filter for selectively transmitting light with specific wavelength such as red, green, and blue, and the color material layer of each color is regularly arrayed.

A metal material using chrome oxide or a resin material including black particles dispersed in resin can be used for the black matrix 203. In the first preferred embodiment, a so-called resin BM is employed. The resin BM is made of the latter resin material that is widely used thanks to excellent burn-in property in the liquid crystal display device of the transverse electric field mode. Since the black particles dispersed in resin are conductive materials such as carbon or titanium, the resin BM has conductivity to some extent, although the resistance of the resin BM is not so much lower than the metal material.

The opposite substrate 200 is provided with a shield conductive layer 204 made of a transparent conductive film on the outer surface (the surface reverse to the liquid crystal layer 30) of the glass substrate 201. The shield conductive layer 204 is formed to cover at least the display area 11 of the glass substrate 201, and grounded through a predetermined ground structure (the ground structure for the shield conductive layer 204 will be described later). The shield conductive layer 204 is effective means to prevent display failure caused by charging due to static electricity or an external electric field on the liquid crystal display panel 10 of the transverse electric field mode.

On the other hand, the TFT array substrate 100 is made of a glass substrate 101 that is a second transparent substrate. Pixel electrodes 102, common electrodes 103, TFTs 104, gate wires 105, source wires 106, common wires 107, an insulating film 108 and the like are formed in the display area 11 on the inner surface (the surface close to the liquid crystal layer 30) of the glass substrate 101.

The pixel electrode 102 and the common electrode 103 are made of a transparent conductive film, and when a voltage according to an image signal is applied thereto, they generate an electric field in the transverse direction (the direction parallel to the surface of the TFT array substrate 100) for driving the liquid crystal in the liquid crystal layer 30. The TFT 104 is a switching element that applies the voltage according to the image signal to the pixel electrode 102 connected to its source electrode. The gate wire 105 supplies a drive signal (gate signal) to a gate electrode of the TFT 104, while the source wire 106 supplies an image signal to the source electrode of the TFT 104. The common wire 107 supplies a predetermined common potential to the common electrode 103. The pixel electrodes 102, the TFTs 104, the gate wires 105, and the source wires 106 are covered by the insulating film 108 (for the sake of convenience of illustration, an interlayer insulating film between the pixel electrode 102 and the common electrode 103 is included in the insulating film 108). The common electrodes 103 are formed on the insulating film 108, i.e., on the outermost surface of the TFT array substrate 100.

In the present preferred embodiment, the common wire 107 is formed in the same layer (the uppermost layer of the TFT array substrate 100) as the common electrode 103 so as to be connected to the common wire 103 in the display area 11, while the common wire 107 is formed in the same layer (below the insulating film 108) as the gate wire 105 in the frame area 12. Notably, the common wire 107 may be formed below the insulating film 108, and the common electrode 103 on the insulating film 108 may be connected to the common wire 107 via a contact hole, even in the display area 11.

The insulating film 108 includes a single-layer transparent insulating film, or a stacked film having a plurality of transparent insulating films. Although not illustrated, an orientation film for aligning the liquid crystal in the liquid crystal layer 30 is formed in the display area 11 on the surface of the TFT array substrate 100 close to the liquid crystal layer 30.

In the first preferred embodiment, the interdigital or grid common electrode 103 having a slit is arranged above the sheet-type pixel electrode 102 so as to be opposite to the pixel electrode 102. Alternatively, the shapes and the vertical relationship of these electrodes may be reversed, i.e., the interdigital or grid pixel electrode 102 may be arranged above the sheet-type common electrode 103 so as to be opposite to the common electrode 103. The specific pattern shape of the pixel electrode 102 and the common electrode 103 may be the same as those used in a liquid crystal panel of a known FFS mode.

As illustrated in FIG. 1, a plurality of gate wires 105 extend parallel to one another, and plural source wires 106 extend parallel to one another in the display area 11 of the TFT array substrate 100. The plurality gate wires 105 and the plurality of source wires 106 are arranged to cross each other. The common wires 107 in the number equal to the gate wires 105 are arranged parallel to the gate wires 105.

Since each of the area enclosed by the gate wire 105 and the source wire 106 becomes a pixel area, the plurality of pixels are arranged in an array (matrix). The pixel electrode 102, the common electrode 103, and the TFT 104 are formed for each pixel. The common electrode 103 of each pixel is connected to the common wire 107, and is set to have the same potential (common potential).

The TFT array substrate 100 and the opposite substrate 200 are respectively rectangle, and the TFT array substrate 100 is larger than the opposite substrate 200. Therefore, when the TFT array substrate 100 and the opposite substrate 200 are superimposed, a part of the frame area 12 of the TFT array substrate 100 protrudes from the end of the opposite substrate 200. In FIG. 1, a part of the right frame area 12a and a part of the top frame area 12b protrude from the end of the opposite substrate 200.

A drive IC (Integrated Circuit) chip 109 (gate-side drive IC chip) and a signal terminal 110 (gate-side signal terminal) for inputting a signal to the gate-side drive IC chip 109 are mounted on the surface opposite to the opposite substrate 200 in the frame area 12a protruding from the end of the opposite substrate 200. The gate-side signal terminal 110 is formed to have a plurality of rectangular pads arranged in the vertical direction (Y direction) in FIG. 1. A control substrate 112 (gate-side control substrate) for controlling the operation of a gate-side drive IC chip 109 is connected to the gate-side signal terminal 110 via an FFC (Flexible Flat Cable) 111 (gate-side FFC) that is a connection wire.

The gate-side control substrate 112 includes a control IC chip that generates a control signal for controlling the gate-side drive IC chip 109, and inputs the control signal to the gate-side signal terminal 110. The control signal inputted to the gate-side signal terminal 110 is inputted to the gate-side drive IC chip 109. The gate-side drive IC chip 109 generates a drive signal (gate signal) of the TFT 104 connected to the gate wire 105 based upon the control signal. The gate signal generated by the gate-side drive IC chip 109 is supplied to the gate wire 105 through a wire (gate lead wire), not illustrated, drawn to the gate-side drive IC chip 109 in the frame area 12a from the gate wire 105 in the display area 11, and then inputted to the gate electrode of the TFT 104 connected to the gate wire 105. In the present preferred embodiment, the gate lead wire is supposed to be formed in the frame area 12a.

On the other hand, a drive IC chip 113 (source-side drive IC chip) that supplies an image signal to the source wire 106 and a signal terminal 114 (source-side signal terminal) for inputting a signal to the source-side drive IC chip 113 are mounted on the surface opposite to the opposite substrate 200 in the frame area 12b protruding from the end of the opposite substrate 200. The source-side signal terminal 114 is formed to have a plurality of rectangle pads arranged in a horizontal direction (X direction) in FIG. 1. A control substrate 116 (source-side control substrate) that controls the operation of the source-side drive IC chip 113 is connected to the source-side signal terminal 114 via an FFC 115 (source-side FFC).

The source-side control substrate 116 includes a control IC chip that generates a control signal for controlling the source-side drive IC chip 113 and an image signal, and inputs these signals to the source-side signal terminal 114. The control signal and the image signal inputted to the source-side signal terminal 114 are inputted to the source-side drive IC chip 113. The source-side drive IC chip 113 outputs the image signal to the source wire 106 at a timing based upon the control signal. The image signal outputted from the source-side drive IC chip 113 is supplied to the source wire 106 through a wire (source lead wire), not illustrated, drawn to the source-side drive IC chip 113 in the frame area 12b from the source wire 106 in the display area 11, and then inputted to the pixel electrode 102 of each pixel through the TFT 104. In the present preferred embodiment, the source lead wire is supposed to be formed in the frame area 12b.

As illustrated in FIG. 1, a conductive layer 117 enclosing the display area 11 is formed in the frame area 12 of the liquid crystal panel 10 so as to fill a gap between the seal material 31 and the display area 11 in the first preferred embodiment. Specifically, the conductive layer 117 is formed in the frame area 12 on all sides, including not only the frame area 12a where the gate lead wire is formed and the frame area 12b where the source lead wire is formed, but also the frame areas 12c and 12d where the gate lead wire and the source lead wire are not formed.

As illustrated in FIG. 2, the conductive layer 117 is formed to cover the outermost surface of the TFT array substrate 100. In the first preferred embodiment, the conductive layer 117 is formed from a layer of the transparent conductive film same as the common electrode 103 formed in the display area 11. Accordingly, the pattern of the conductive layer 117 can simultaneously be formed with the pattern of the common electrode 103, which prevents the number of manufacturing processes from increasing due to the formation of the conductive layer 117.

When the shape and the vertical relationship of the pixel electrode 102 and the common electrode 103 in FIG. 2 are reversed, which means the interdigital or grid pixel electrode 102 is arranged above the sheet-type common electrode 103 so as to be opposite to the common electrode 103, the conductive layer 117 may be formed from a layer of the transparent conductive film same as the pixel electrode 102 in order that the conductive layer 117 becomes the uppermost layer of the TFT array substrate 100.

It is desirable that a specific fixed potential be supplied to the conductive layer 117. In the first preferred embodiment, the common potential same as that of the common wire 107 and the common electrode 103 is supplied to the conductive layer 117. When the potential of the conductive layer 117 is fixed to the common potential, an adverse influence to an image displayed in the display area 11 by the conductive layer 117 can be prevented, even if the conductive layer 117 is arranged around the display area 11.

When the common potential is supplied to the conductive layer 117 as described above, a part of the conductive layer 117 may be used as a path (the common wire 107 formed in the frame area 12) that supplies the common potential to the common wire 107 in the display area 11. The conductive layer 117 to which the common potential is supplied can also be utilized as a bypass path of the common wire 107 in the case where the common wire 107 formed in the frame area 12 is arranged to cross the gate wire 105. The conductive layer 117 to which the common potential is supplied may be formed together with the common wire 107 formed in the frame area 12, and the conductive layer 117 may be used as a bypass of the common wire 107. This configuration can reduce a resistance of the supplying path of the common potential, thereby bringing an effect of stabilizing the common potential in the liquid crystal panel 10.

When the common electrode 103 formed in the display area 11 is formed on the uppermost layer of the TFT array substrate 100 as in the first preferred embodiment, the common electrode 103 may be formed from the layer of the same transparent conductive film as the conductive layer 117, and the conductive layer 117 and the common electrode 103 may be connected to each other by the same transparent conductive film, i.e., the conductive layer 117 and the common electrode 103 may be formed in a combined pattern in which the conductive layer 117 and the common electrode 103 are connected at least partly. According to this configuration, the common potential same as the common electrode 103 can relatively easily be supplied to the conductive layer 117.

A polarizing plate 120 is provided on the outer surface of the TFT array substrate 100. A polarizing plate 220 is provided on the outer surface of the opposite substrate 200 on the shield conductive layer 204. The polarizing plate 220 and the polarizing plate 120 cover at least the display area 11 of the liquid crystal panel 10.

The shield conductive layer 204 of the opposite substrate 200 is grounded. Any structure can be employed for the ground structure of the shield conductive layer 204. In the present preferred embodiment, an earth pad 118 to which a ground potential is supplied is provided in the frame area 12a that protrudes from the end of the opposite substrate 200, and the earth pad 118 and the shield conductive layer 204 are electrically connected with a conductive tape 119. The shield conductive layer 204 is mostly covered by the polarizing plate 220, but a part thereof is exposed from the opposite substrate 200. One end of the conductive tape 119 is adhered onto the exposed portion of the shield conductive layer 204, while the other end is adhered to the earth pad 118.

The earth pad 118 is grounded through the gate-side signal terminal 110 and the gate-side FFC 111. The one formed by applying a conductive adhesive onto a base material made of a metal foil such as Al foil or Cu foil can be used for the conductive tape 119. A commonly-marketed product can be used.

The configuration of the liquid crystal panel 10 according to the first preferred embodiment is as stated above. Although not illustrated, a backlight unit and an optical sheet that adjusts light emitted from the backlight unit are provided on the back surface of the liquid crystal panel 10, and they are stored in a housing formed with an opening on the front side (viewing side) of the display area 11, whereby a liquid crystal display device is completed.

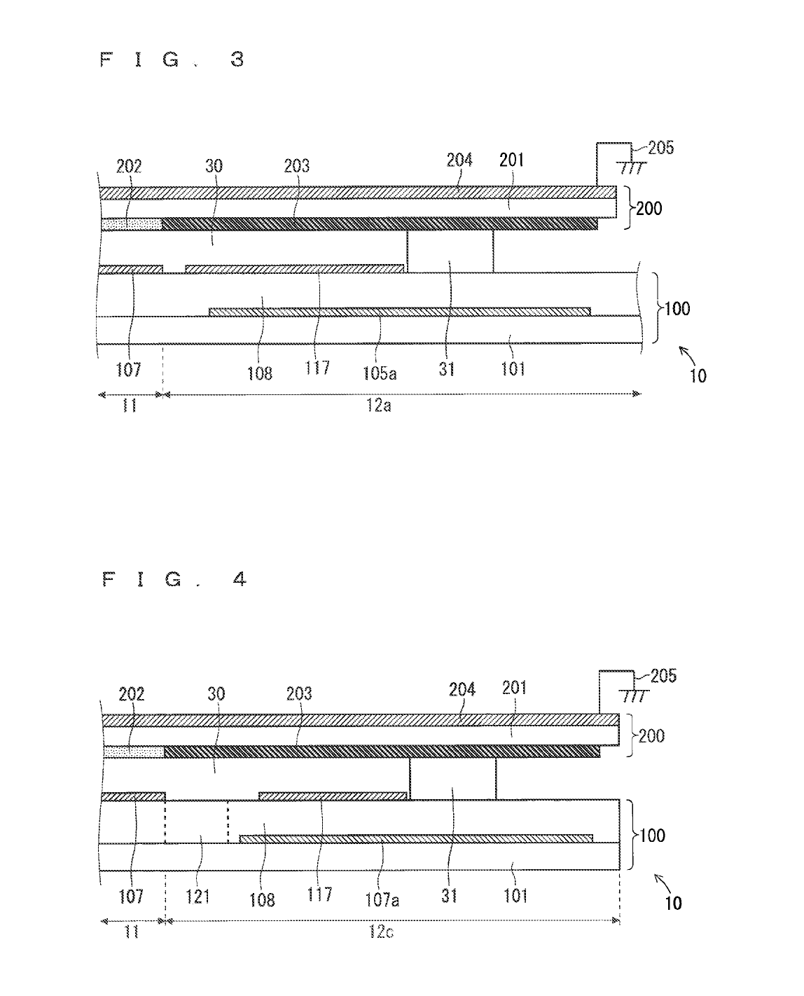

Next, the effect obtained by the liquid crystal display device using the liquid crystal panel 10 according to the first preferred embodiment will be described. FIGS. 3 and 4 are sectional views illustrating the vicinity of the frame area 12 of the liquid crystal panel 10 in the first preferred embodiment, wherein FIG. 3 is illustrates the vicinity of the frame area 12a, and FIG. 4 illustrates the vicinity of the frame area 12c. In these figures, the components same as those illustrated in FIGS. 1 to 4 are identified by the same numerals.

As illustrated in FIG. 3, the gate lead wire 105a is provided below the insulating film 108 in the frame area 12a of the TFT array substrate 100. On the other hand, as illustrated in FIG. 4, a test circuit portion 121 for performing a conduction test for each wire and an operation test of the TFT 104 during the manufacture of the TFT array substrate 100 is provided in the frame area 12c of the TFT array substrate 100, and a test pad (not illustrated) on which a test needle is put is provided on a part thereof. The common wire 107 in the display area 11 is provided on the uppermost layer of the TFT array substrate 100, but a common wire 107a in the frame area 12c is provided below the insulating film 108.

The shield conductive layer 204 formed on the opposite substrate 200 is grounded through the ground structure 205 (the earth pad 118 and the conductive tape 119 in FIG. 2).

Although the section of the frame areas 12b and 12d is not illustrated, the conductive layer 117 covering the outermost surface of the TFT array substrate 100 is formed between the display area 11 and the seal material 31 in all frame areas 12a to 12d on the liquid crystal panel 10 according to the first preferred embodiment. Specifically, the conductive layer 117 is formed not only in the frame area 12a where the gate lead wire 105a is formed but also in the frame area 12c where the common wire 107a is formed, and further, the conductive layer 117 is formed to cover the outermost surface of the TFT array substrate 100 in the frame area 12d where the common wire 107a is formed, like the frame area 12b where the source lead wire is formed and the frame area 12c.

In FIG. 3, the conductive layer 117 is not formed on the test circuit portion 121, since the test circuit portion 121 in the frame area 12c has relatively a narrow area, so that it hardly affects the display unevenness, and further, the conductive layer 117 interferes with the test pad formed on the test circuit portion 121. However, the conductive layer 117 may be formed on the test circuit portion 121 in the range except for the test pad.

According to the first preferred embodiment, the conductive layer 117 covering the outermost surface of the TFT array substrate 100 is provided in the frame area 12 (12a to 12d) on all sides including the side where the gate lead wire 105a is not provided in the liquid crystal display device of the transverse electric field mode such as the FFS mode. Therefore, even if the ground structure 205 for the shield conductive layer 204 formed on the opposite substrate 200 becomes non-functional, the local occurrence of different electric field on the end of the display area 11 where the display unevenness is likely to occur can be prevented, whereby the generation of the display unevenness can be prevented.

As for the problem of the display unevenness, if the resistance value of the black matrix 203 on the opposite substrate 200 is low, many charges are likely to be induced in the frame area 12 where the black matrix 203 is entirely formed. When the black matrix 203 is made of a resin material having a higher resistance value than the metal material, the distribution of the induced charges is difficult to be made uniform, so that local display unevenness is likely to be generated on the outer periphery of the display area 11. Accordingly, the effect of preventing the display unevenness obtained by the conductive layer 117 appears more noticeably on the liquid crystal panel 10 including the black matrix 203 made of the resin material having relatively higher resistance value.

When the resistance value on the surface of the seal material 31 is smaller than the resistance value of the liquid crystal in the liquid crystal layer 30, the charges charged on the surface of the opposite substrate 200 flow into the conductive layer 117 via the surface of the seal material 31 in the vicinity of the seal material 31. Therefore, the potential difference between the surface of the opposite substrate 200 and the surface of the TFT array substrate 100, i.e., the electric field applied to the liquid crystal layer 30 in the longitudinal direction is relaxed, whereby the generation of the display unevenness on the end of the display area 11 can be prevented.

As described above, the liquid crystal panel 10 according to the first preferred embodiment can prevent the occurrence of the display defect caused by the display unevenness, even when the ground structure 205 for the shield conductive layer 204 becomes non-functional, thereby contributing to enhancement in reliability of the liquid crystal display device.

In the first preferred embodiment, the gate lead wire is provided in the frame area 12a where the gate-side drive mechanism (the gate-side drive IC chip 109, the gate-side control substrate 112, and the like) is mounted, while the source lead wire is provided in the frame area 12b where a source-side drive mechanism (the source-side drive IC chip 113, the source-side control substrate 116, and the like) is mounted, out of four sides of the liquid crystal panel 10. However, the present invention is not limited to the liquid crystal panel having the above-mentioned configuration.

For example, in a compact liquid crystal display device, the gate-side drive mechanism and the source-side drive mechanism are mostly both mounted in a frame area on one side out of four sides of the liquid crystal panel. In this case, the gate lead wire is mostly mounted in frame areas of three sides including one side on which the drive mechanism is mounted and two sides adjacent to this one side out of four sides of the liquid crystal panel. The present invention is applicable to the liquid crystal panel having the above configuration. The effect similar to the effect described above can be obtained by forming a conductive layer, which covers the outermost surface of the TFT array substrate 100, on the frame areas of all sides including the side where the gate lead wire is not arranged.

Specifically, the present invention is applicable to a liquid crystal panel having a configuration in which a gate lead wire is arranged in frame areas of one to three sides out of four sides, and it is only necessary to form the conductive layer, which covers the outermost surface of the TFT array substrate, on all sides including the side where the gate lead wire is not arranged.

### Second Preferred Embodiment

In the first preferred embodiment, the conductive layer 117 covering the outermost surface of the TFT array substrate 100 is formed only in the liquid crystal layer (inside the seal material 31). However, the position where the conductive layer is formed is not limited thereto.

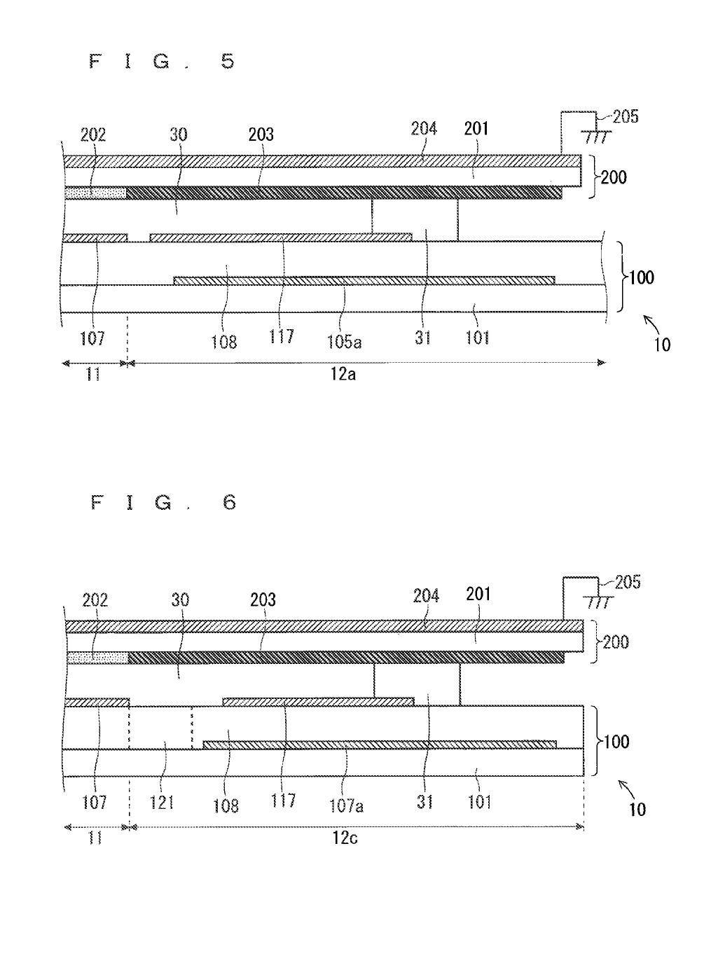

FIGS. 5 and 6 are sectional views illustrating a vicinity of a frame area 12 of a liquid crystal panel 10 according to a second preferred embodiment, wherein FIG. 5 illustrates a vicinity of a frame area 12a, while FIG. 6 illustrates a vicinity of a frame area 12c. In the second preferred embodiment, a conductive layer 117 is arranged so as to overlap a seal material 31, i.e., a conductive layer 117 is arranged such that an outer end of the conductive layer 117 overlaps the seal material 31. Although frame areas 12b and 12d are not illustrated, the conductive layer 117 may be arranged such that the outer end of the conductive layer 117 overlaps the seal material 31 in all frame areas 12a to 12d.

When the resistance value on the surface of the seal material 31 is smaller than the resistance value of the liquid crystal in the liquid crystal layer 30, charges accumulated on the surface of the opposite substrate 200 efficiently flow through the conductive layer 117 by allowing the conductive layer 117 to be in contact with the seal material 31 as in the second preferred embodiment. Thus, the operation of relaxing the potential difference between the surface of the opposite substrate 200 and the surface of the TFT array substrate 100, i.e., the electric field applied to the liquid crystal layer 30 in the longitudinal direction is increased, whereby the effect of preventing the generation of the display unevenness is enhanced.

The seal material 31 may be made of a conductive material. Specifically, a resin material including spherical conductive particles, such as resin, with a gold coating may be used as the seal material 31. According to this configuration, the charges accumulated on the surface of the opposite substrate 200 are allowed to flow through the conductive layer 117 via the overlap portion of the inside of the seal material 31, the seal material 31, and the conductive layer 117, whereby the effect described above is significantly obtained. As an allowable value of the resistance value when the seal material 31 is made of a conductive material, a desirable value is approximately a resistance value through a conductor such as a metal, as specifically described above. However, the effect similar to the effect in the case where the resistance value on the surface of the seal material 31 is smaller than the resistance value of the liquid crystal in the liquid crystal layer 30 can be obtained, if the resistance value of the seal material 31 made of the conductive material is smaller than at least the resistance value of the liquid crystal in the liquid crystal layer 30. In the first preferred embodiment, the seal material 31 may similarly be made of a conductive material.

Since the end of the conductive layer 117 reaches the seal material 31, all areas in the vicinity of the seal material 31 is covered by the conductive layer 117, whereby the operation of shielding the electric field from the gate lead wire 105a, the common wire 107a, and the source lead wire (not illustrated), which are arranged below the conductive layer 117, can maximally be exhibited.

### Third Preferred Embodiment

In the first preferred embodiment, the conductive layer 117 covering the outermost surface of the TFT array substrate 100 is made of a transparent conductive film same as that for the common electrode 103 or the pixel electrode 102 provided in the display area 11. However, the material of the conductive layer 117 is not limited thereto.

In the third preferred embodiment, the conductive layer 117 is made of a low-resistance metal film such as an Al film. According to this configuration, the charges accumulated on the opposite substrate 200 more efficiently flow through the conductive layer 117, whereby the operation of preventing the display unevenness is further enhanced. The third preferred embodiment can be applied to the liquid crystal panel 10 according to the second preferred embodiment.

### Fourth Preferred Embodiment

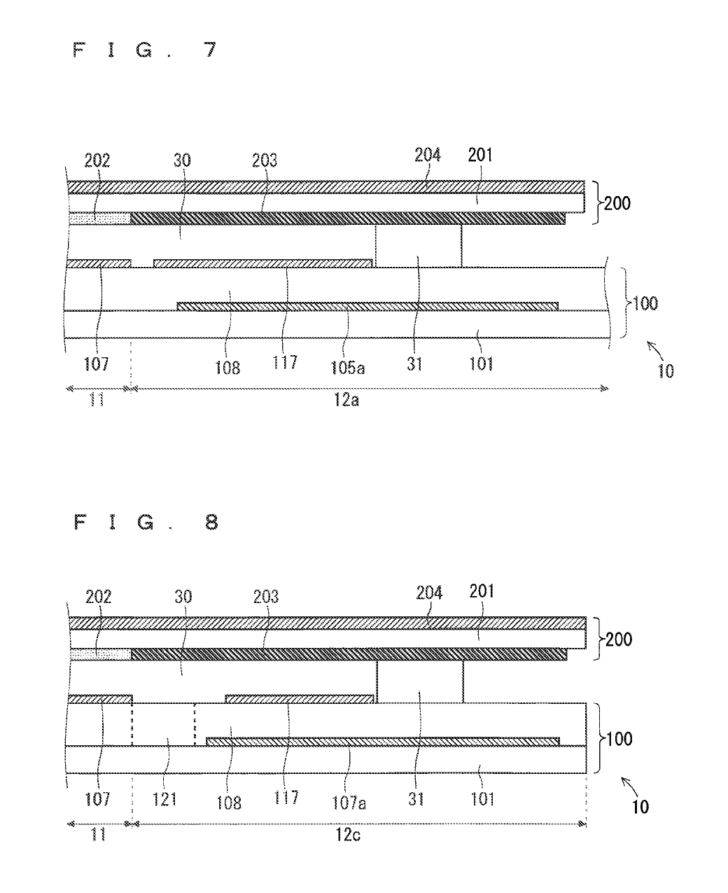

FIGS. 7 and 8 are sectional views illustrating a vicinity of a frame area 12 of a liquid crystal panel 10 according to a fourth preferred embodiment, wherein FIG. 7 illustrates a vicinity of a frame area 12a, while FIG. 8 illustrates a vicinity of a frame area 12c. The configuration of the liquid crystal panel 10 according to the fourth preferred embodiment is almost the same as that in the first preferred embodiment, but a ground structure (the ground structure 205 in FIGS. 3 and 4) for a shield conductive layer 204 of an opposite substrate 200 is eliminated.

As described in the first preferred embodiment, the liquid crystal panel 10 according to the present invention can prevent the local occurrence of different electric field on the end of the display area 11, and the generation of the display unevenness can also be prevented, even when the ground structure for the shield conductive layer 204 becomes non-functional. Therefore, the ground structure for the shield conductive layer 204 can be eliminated.

In the fourth preferred embodiment, the manufacturing process of the liquid crystal panel 10 is simplified by eliminating the ground structure for the shield conductive layer 204. Since the structures of the TFT array substrate 100 and the opposite substrate 200 become simple, a yield is expected to be enhanced.

In the fourth preferred embodiment, the shield conductive layer 204 needs not to have a potential fixed to a specific potential, but may be in a floating potential condition. Therefore, a conductive film formed on the outer surface of the opposite substrate 200 for the other purpose may also be used as the shield conductive layer 204.

For example, in a double screen liquid crystal display device or a 3D liquid crystal display device that displays an image in a different direction, a light-shielding film called “parallax barrier” is provided on the front surface of the opposite substrate 200. When a conductive light-shielding film is used as the parallax barrier, this film can be used as the shield conductive layer 204. In a liquid crystal display device including a mutual capacitive touch panel arranged on the front surface of the opposite substrate 200, for example, a transparent conductive film for noise shield is provided between the touch panel and the opposite substrate 200. This film can be used as the shield conductive layer 204.

The polarizing plate 220 arranged on the front surface of the opposite substrate 200 illustrated in FIG. 2 is made of a conductive material, and this may be used as the shield conductive layer 204. Alternatively, an adhesive used for bonding the polarizing plate 220 on the opposite substrate 200 is made conductive, and a layer of the adhesive can be used as the shield conductive layer 204. In any case, the shield conductive layer 204 is not grounded in the present preferred embodiment, whereby the shield conductive layer 204 is not necessarily exposed to the outside of the opposite substrate 200.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display panel of a transverse electric field mode comprising:
a TFT array substrate on which a TFT (Thin Film Transistor) for each pixel is arranged;
an opposite substrate arranged opposite to said TFT array substrate, said opposite substrate including a shield conductive layer on an outer surface; and
a liquid crystal layer sandwiched between said TFT array substrate and said opposite substrate, wherein
said TFT array substrate comprises:
a gate wire connected to a gate electrode of said TFT;
a gate lead wire that draws said gate wire to a frame area outside a display area; and
a conductive layer that covers an outermost surface of said TFT array substrate in said frame area on all sides including a side where said gate lead wire is not arranged.

2. The liquid crystal display panel according to claim 1, wherein said shield conductive layer is in a floating condition not fixed to a specific potential.

3. The liquid crystal display panel according to claim 1, wherein a common potential that is a potential of a common electrode of each pixel is supplied to said conductive layer.

4. The liquid crystal display panel according to claim 1, wherein said conductive layer is made of a transparent conductive film same as that of a pixel electrode or a common electrode of each pixel.

5. The liquid crystal display panel according to claim 1, wherein said conductive layer is made of a metal film.

6. The liquid crystal display panel according to claim 1, wherein said opposite substrate further comprises a black matrix, which is formed by dispersing black particles into resin, on a surface close to said liquid crystal layer.

7. The liquid crystal display panel according to claim 2, wherein said shield conductive layer is a light-shielding conductive film forming a parallax barrier.

8. The liquid crystal display panel according to claim 2, wherein said shield conductive layer is a transparent conductive film provided between a touch panel arranged on a front surface of said opposite substrate and said opposite substrate as a noise shield.

9. The liquid crystal display panel according to claim 1, further comprising:
a seal material that is formed on said frame area between said TFT array substrate and said opposite substrate for sealing said liquid crystal layer, wherein
a resistance value on a surface of said seal material is smaller than a resistance value of said liquid crystal layer.

10. The liquid crystal display panel according to claim 1, further comprising:
a seal material that is formed on said frame area between said TFT array substrate and said opposite substrate for sealing said liquid crystal layer, wherein
said seal material is made of a conductive material.
